(19) United States
(12) Patent Application Publication
(10) Pub. No.: US 2007/0275669 A1
(43) Pub. Date: Nov. 29, 2007

(54) Method, Apparatus and Signal for, Transmitting/Receiving Information Comprising Primary and Secondary Messages in a Same Transmission

(75) Inventors: Ronald Rietman, Eindhoven (NL); Job Cornelis Oostveen, Eindhoven (NL); Wilhelmus Johannes Van Houtum, Eindhoven (NL); Ludovicus Marinus Gerardus Maria Tolhuizen, Eindhoven (NL); Sebastian Egner, Eindhoven (NL); Constant Paul Marie Jozef Baggen, Eindhoven (NL); Johan Paul Marie Gerard Linnartz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,705

(22) PCT Filed: May 31, 2005
(86) PCT No.: PCT/IB05/51766

§ 371 Date: Nov. 28, 2006

(30) Foreign Application Priority Data
Jun. 1, 2004 (EP) 04076609.9

(51) Int. Cl. H04L 12/56

(52) U.S. Cl. 455/70

(57) ABSTRACT

Transmitters (116) for transmitting information and receivers (126) for receiving the information are defined by the information comprising a primary message and a secondary message combined in a same transmission or a same reception, which primary and secondary messages comprise communication protocol signaling messages, to avoid that a protocol conversion arrangement needs to be added to and to be placed between the transmitter (116) and the receiver (126). This increases the efficiency of the transmitter (116) and the receiver (126). The primary and secondary communication protocol messages are in accordance with first and second standards such as 802.11 a and later standards such as 802.11 n. The receiver (126) is able to detect the primary or secondary communication protocol message in case of the receiver (126) being in accordance with the first or second standard. The secondary message is embedded in the primary message via a modulation or via a selection of a subset of a set of a modulation constellation.

The invention relates to a transmitter for transmitting information to a receiver, and also relates to a receiver for receiving information from a transmitter, and to a device comprising the transmitter and/or comprising the receiver, to a method for exchanging information between a transmitter and a receiver, and to a signal.

Examples of such a device are mobile phones, personal digital assistants, desktop and/or laptop and/or handheld computers, and wireless interfaces.

A prior art arrangement is known from EP 0 742 662 A1, which discloses a protocol conversion arrangement. This protocol conversion arrangement is placed between a first arrangement based on a first protocol and a second arrangement based on a second protocol and compares a first information element with a stored second information element and possibly with a stored third information element and forwards either the first information element or the second information element in dependence of one or more comparison results.

The known arrangement is disadvantageous, inter alia, owing to the fact that it forms an additional arrangement that has to be added to and that has to be placed between the first and second arrangements.

It is a first object of the invention, inter alia, to provide a transmitter that does not require an additional arrangement to be added to and to be placed between the transmitter and a receiver. It is a second object of the invention, inter alia, to provide a receiver that does not require an additional arrangement to be added to and to be placed between a transmitter and the receiver. Further objects of the invention are, inter alia, to provide a device comprising such a transmitter and/or comprising such a receiver, to provide a method for exchanging information between a transmitter and a receiver, and to provide a signal to be exchanged between a transmitter and a receiver, which transmitter and which receiver do not require an additional arrangement to be added to and to be placed between them.

The transmitter according to the invention for transmitting information to a receiver is defined by the information comprising a primary message and a secondary message combined in a same transmission, which primary and secondary messages comprise communication protocol signaling messages. The receiver according to the invention for receiving information from a transmitter is defined by the information comprising a primary message and a secondary message combined in a same transmission, which primary and secondary messages comprise communication protocol signaling messages.

By introducing a primary message and a secondary message each comprising at least one communication protocol signaling message, which primary and secondary messages form part of information transmitted in a same transmission from a transmitter point of view or which primary and secondary messages form part of information received in a same reception from a receiver point of view, it is no longer necessary to add a protocol conversion arrangement to and to place this protocol conversion arrangement between the transmitter and the receiver. This is a great advantage.

The primary and secondary messages may comprise further messages and/or further information, and the information may comprise further messages and/or further information, and a same transmission and/or a same reception may comprise further messages and/or further information, without departing from the scope of this invention. The transmitter according to the invention and the receiver according to the invention do not require an additional arrangement to be placed between them, without having excluded that an additional arrangement is (going to be) placed between them.

The invention is further advantageous, inter alia, in that a combination of the primary and secondary messages transmitted in a same transmission or received in a same reception increases the efficiency of the transmitter and the receiver.

An aspect of the invention is that, in one transmission and/or in one reception, the primary and secondary messages comprise primary and secondary communication protocol signaling messages, which primary communication protocol signaling message is destined for the receiver in case of the receiver being of a primary type and which secondary communication protocol signaling message is destined for the receiver in case of the receiver being of a secondary type. Thereby, the primary and secondary communication protocol signaling messages are different messages and the primary and secondary receiver types are different receiver types. So, in case of the receiver being of the primary type, it can detect the primary communication protocol signaling message and in case of the receiver being of the secondary type, it can detect at least the secondary communication protocol signaling message, without the transmitter needing to know the receiver type.

An embodiment of the transmitter according to the invention is defined by the primary communication protocol message being in accordance with a first standard and the secondary communication protocol message being in accordance with a second standard. An embodiment of the receiver according to the invention is defined by the primary communication protocol message being in accordance with a first standard and the secondary communication protocol message being in accordance with a second standard. For both embodiments, the receiver is able to detect the primary communication protocol message in case of the receiver being in accordance with the first standard and the receiver is able to detect the secondary communication protocol message in case of the receiver being in accordance with the second standard.

By introducing the different communication protocol messages that are in accordance with different standards, these standards can be used in parallel without a protocol conversion arrangement needing to be added to and needing to be placed between the transmitter and the receiver. By making the receiver able to detect the respective primary and/or secondary communication protocol messages in case of the receiver being in accordance with the respective first and/or second standards, two different receivers can be used for receiving the same information. This for example allows older and newer receivers to be used in parallel in one system comprising one or more transmitters and one or more older receivers and one or more newer receivers.

In a minimum situation, the receiver which is in accordance with the first standard should be able to detect the primary communication protocol message and the receiver which is in accordance with the second standard should be able to detect the secondary communication protocol message. In a preferred situation, the receiver which is in accordance with the second standard can also detect the primary communication protocol message. The term “standard” may correspond with “standard” or “protocol” but may also correspond with “class” or “mode” or “configuration” and should not be interpreted too restrictedly. The term “a receiver being able to detect a specific communication protocol message in case of the receiver being in accordance with a specific standard” should not be interpreted too restrictedly too and may also comprise “a switchable receiver being able to detect a specific communication protocol message in case of the receiver being switched into a specific standard or protocol or class or mode or configuration”.

An embodiment of the transmitter according to the invention is defined by the first standard being 802.11a and the second standard being a later standard. An embodiment of the receiver according to the invention is defined by the first standard being 802.11a and the second standard being a later standard. As a result, the later standard such as for example the 802.11n standard has become backward compatible with the 802.11a standard. Other standards are not to be excluded.

An embodiment of the transmitter according to the invention is defined by the primary and secondary messages being digital messages. An embodiment of the receiver according to the invention is defined by the primary and secondary messages being digital messages. As a result, digital watermarking techniques have been introduced into the communication protocol techniques.

An embodiment of the transmitter according to the invention is defined by the secondary message being embedded in the primary message via a modulation of at least a part of the primary message and/or via a selection of a subset of a set of a modulation constellation, the set of the modulation constellation being used as a reference grid. An embodiment of the receiver according to the invention is defined by the secondary message being embedded in the primary message via a modulation of at least a part of the primary message and/or via a selection of a subset of a set of a modulation constellation, the set of the modulation constellation being used as a reference grid.

The modulation may comprise an amplitude modulation, a power modulation, a frequency modulation and/or a phase modulation, without excluding other modulations. The selection of the subset of the set of the modulation constellation may comprise a selection of a subset of a set of an amplitude quadrature modulation constellation, without excluding other constellations. As a result, a highly efficient transmitter and a highly efficient receiver have been created.

An embodiment of the transmitter according to the invention is defined by the secondary message defining a type of frame used in the information and/or a number of antennas used by the transmitter and/or a scheme and/or a rate and/or a code. An embodiment of the receiver according to the invention is defined by the secondary message defining a type of frame used in the information and/or a number of antennas used by the transmitter and/or a scheme and/or a rate and/or a code.

The type of frame for example indicates a certain frame of the information being a 802.11a frame or a 802.11n frame, without excluding other kinds of frames. The number of antennas used by the transmitter is for example equal to a number of streams arriving at the receiver, without excluding other situations. The scheme for example defines a modulation scheme used by the transmitter, without excluding other schemes. The rate for example defines a code rate used by the transmitter, without excluding other kinds of rates. The code for example defines an error correction code used by the transmitter, without excluding other kinds of codes, such as transmission codes and encryption codes.

Embodiments of the device according to the invention and of the method according to the invention and of the signal according to the invention correspond with the embodiments of the transmitter according to the invention and of the receiver according to the invention.

The invention is based upon an insight, inter alia, that additional protocol conversions of communication protocol signaling messages between a transmitter and a receiver are to be avoided, and is based upon a basic idea, inter alia, that a primary message and a secondary message are to be combined in a same transmission, which primary and secondary messages each comprise at least one communication protocol signaling message.

The invention solves the problems, inter alia, to provide a transmitter that does not require an additional arrangement to be added to and to be placed between the transmitter and a receiver and to provide a receiver that does not require an additional arrangement to be added to and to be placed between a transmitter and the receiver, and is further advantageous, inter alia, in that a combination of the primary and secondary messages transmitted in a same transmission or received in a same reception increases the efficiency of the transmitter and the receiver.

These and other aspects of the invention will be apparent from and elucidated with reference to the embodiments(s) described hereinafter.

In the drawings:

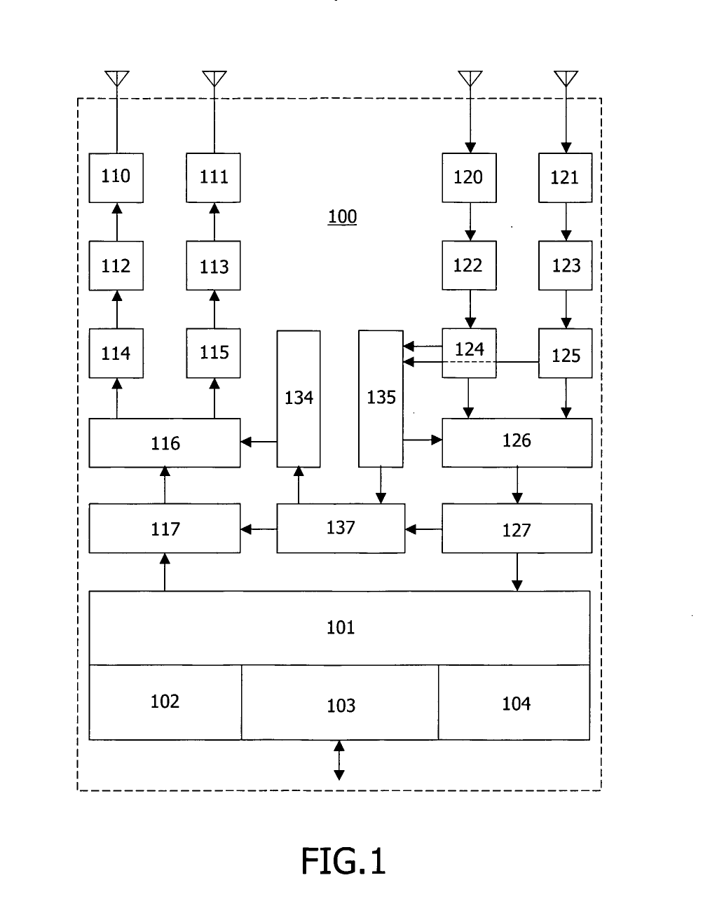

FIG. 1 shows diagrammatically a multi input multi output device,

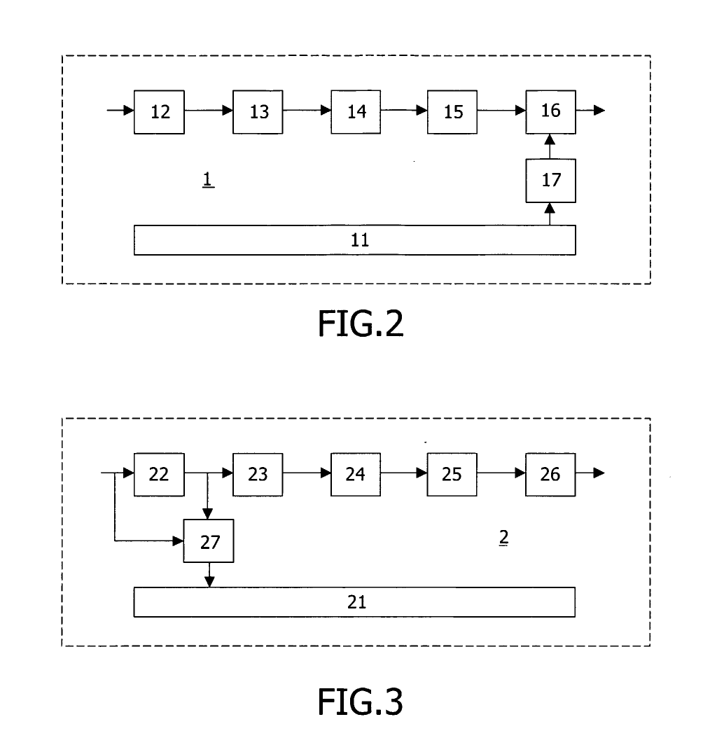

FIG. 2 shows diagrammatically an exemplary transmitter according to the invention,

FIG. 3 shows diagrammatically an exemplary receiver according to the invention,

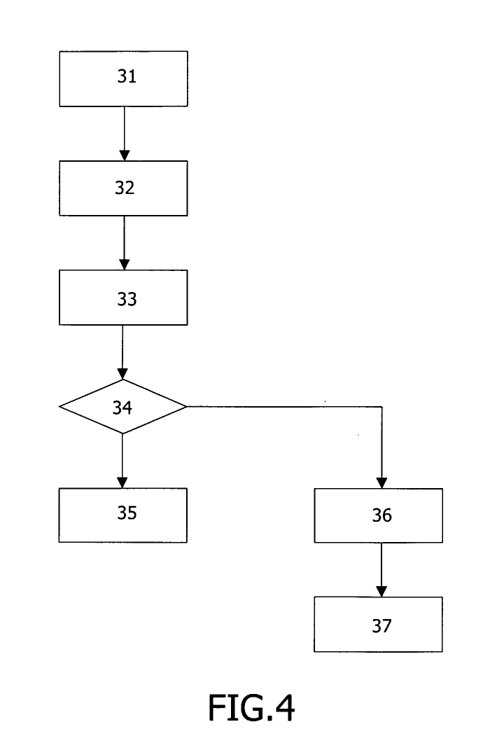

FIG. 4 shows a flow chart of an exemplary detection,

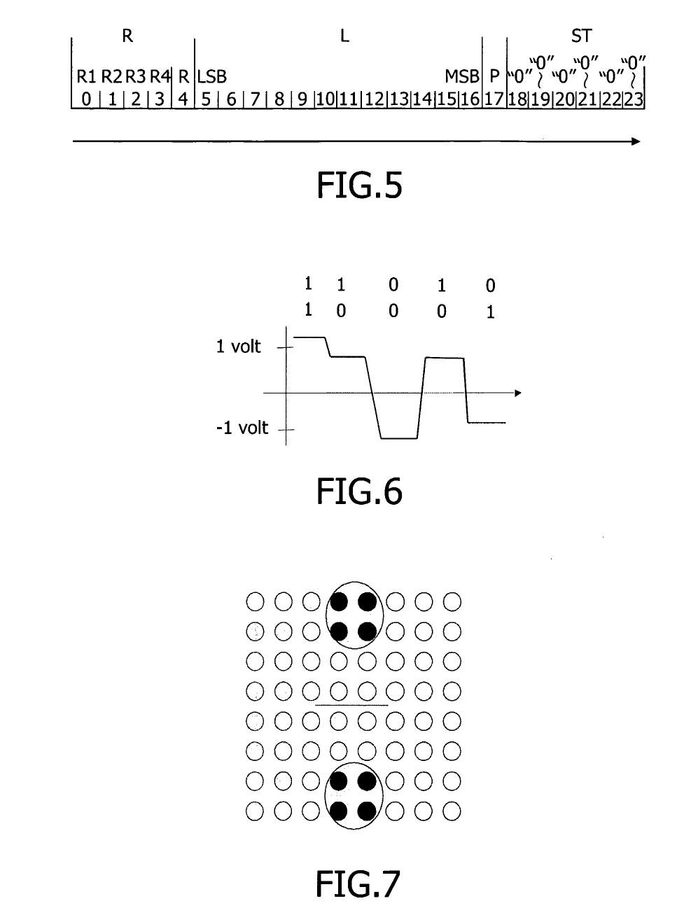

FIG. 5 shows a structure of a field of a 802.11a signal,

FIG. 6 shows an exemplary modulation, and

FIG. 7 shows an exemplary modulation constellation.

The multi input multi output device 100 shown in FIG. 1 such as for example a wireless local area network multi input multi output transceiver comprises for example a first output stage comprising a first transmitting antenna coupled via a first transmitting analog unit 110 and a first digital-to-analog converter 112 and a first multiplexer 114 to a transmitting encoder 116 and comprises for example a second output stage comprising a second transmitting antenna coupled via a second transmitting analog unit 111 and a second digital-to-analog converter 113 and a second multiplexer 115 to the transmitting encoder 116. The transmitting analog units 110 and 111 for example each comprise a power amplifier and the multiplexers 114 and 115 for example each comprise an orthogonal frequency division multiplexer (OFDM). An input of the transmitting encoder 116 is coupled to an output of a pre-processor 117 and a further input of the transmitting encoder 116 is coupled to an output of a transmission controller 134. An input of the transmission controller 134 is coupled to an output of a real time medium access control unit 137. An input of the pre-processor 117 is coupled to an output of an interface unit 101, and a further input of the pre-processor 117 is coupled to a further output of the real time medium access control unit 137.

The multi input multi output device 100 shown in FIG. 1 further comprises for example a first input stage comprising a first receiving antenna coupled via a first receiving analog unit 120 and a first analog-to-digital converter 122 and a first inner receiver 124 to an outer receiver 126 and comprises for example a second input stage comprising a second receiving antenna coupled via a second receiving analog unit 121 and a second analog-to-digital converter 123 and a second inner receiver 125 to the outer receiver 126. The receiving analog units 120 and 121 for example each comprise a front end. An output of the outer receiver 126 is coupled to an input of a post-processor 127 and an input of the outer receiver 126 is coupled to an output of a reception controller 135. A further output of the reception controller 135 is coupled to an input of the real time medium access control unit 137. An output of the post-processor 127 is coupled to an input of the interface unit 101, and a further output of the post-processor 127 is coupled to a further input of the real time medium access control unit 137. Further inputs of the reception controller 135 are coupled to outputs of the inner receivers 124 and 125.

The interface 101 is further coupled to and/or comprises a configuration and system management unit 102, a host unit 103 and a medium access control unit 103. The host unit 102 can further communicate with the units 101 and 103 and is further coupled to further equipment not shown. Each block 116-117-126-127-134-135-137 and/or each unit 101-104 may be hardware or may be software to be run via a processor or may be a mixture of hardware and software.

The exemplary transmitter 1 shown in FIG. 2 comprises a controller 11 and a cyclic redundancy check unit 12 comprising an input for receiving a primary message to be transmitted. An output of the cyclic redundancy check unit 12 is coupled to an input of a scrambler 13, of which an output is coupled to an input of an encoder 14, of which an output is coupled to an input of an interleaver 15, of which an output is coupled to an input of a mapper 16. The mapper 16 comprises a further input coupled to an output of a watermark embedder 17 for embedding a secondary message into the primary message. An input of the watermark embedder is coupled to an output of the controller 11 for receiving the secondary message. The mapper 16 further comprises an output for generating information to be transmitted, which information comprises a primary message and a secondary message combined in a same transmission, which primary and secondary messages comprise communication protocol signaling messages. The transmitter 1 for example corresponds with the transmitting encoder 116 as shown in FIG. 1. Then, the device 100 shown in FIG. 1 has become a device according to the invention.

The exemplary receiver 2 shown in FIG. 3 comprises a controller 21 and a demapper 22 comprising an input for receiving the information, which information comprises the primary message and the secondary message combined in a same reception, which primary and secondary messages comprise communication protocol signaling messages. An input of a watermark detector 27 is coupled to the input of the demapper 22 for also receiving the transmitted information. An output of the demapper 22 is coupled to an input of a de-interleaver 23 and to a further input of the watermark detector 27 for extracting the secondary message from the primary message in the transmitted information. An output of the de-interleaver 23 is coupled to an input of a decoder 24, of which an output is coupled to an input of a descrambler 25, of which an output is coupled to an input of a cyclic-redundancy-check unit 26. An output of the watermark detector 27 is coupled to an input of the controller 21 for supplying the secondary message. The cyclic-redundancy-check unit 26 further comprises an output for generating the primary message. The receiver 2 for example corresponds with the outer receiver 126 as shown in FIG. 1. Then, the device 100 shown in FIG. 1 has become a device according to the invention.

In FIG. 2-3, any unit and/or any block may be hardware or may be software to be run via a processor or may be a mixture of hardware and software.

In the flow chart of an exemplary detection shown in FIG. 4, the following blocks comprise the following meaning:

Block 31: Detection of a preamble of the transmitted information.

Block 32: Decode the detected preamble.

Block 33: Detect the watermark.

Block 34: Compare the detected watermark with a predefined mark. If equal, goto block 35, if unequal, goto block 36.

Block 35: The frame is a frame of a first type, decode accordingly.

Block 36: The frame is a frame of a second (third) type.

Block 37: Decode accordingly.

In case of the primary communication protocol message being in accordance with a first standard “802.11a” and the secondary communication protocol message being in accordance with a second standard “802.11n”, the exemplary detection shown in FIG. 4 becomes as follows. The “802.11a” preamble is detected, block 31. The “802.11a” signal field is decoded, block 32. The embedded codeword B is detected, block 33. The codeword B is compared with a predefined codeword B0, block 34. If equal, the frame is a “802.11a” frame and decodings are to be performed according to the signal field, block 35. If unequal, the codeword B should be equal to Bi with i=1 , . . . ,k, block 36. The frame is a “802.11n” frame that is in a mode i and decodings are to be performed for the rest of the preamble and the rest of the frame. To realize block 33, for example a MMSE detector can be used. Such a detector for example calculates ∥R−HB∥ for all code words B={B0 . . . Bk} and sets B equal to the codeword that minimizes the distance. Other kinds of detectors are not to be excluded.

This way, a primary signal and a secondary signal are exchanged while being combined in the same transmission and/or in a same reception. The secondary signal may be designed in such a manner that it does not affect a detection of the primary signal, even in case the signal is received by a first class of devices (e.g. legacy devices, low power devices, simple devices etc.) that are designed and optimized for the presence of the primary signal only. Meanwhile, a second class of devices (e.g. new devices, more capable devices, or devices with proprietary non-standard innovations etc.) reliably detect both the primary and the secondary signal, or just the secondary signal only.

An important example may be a protocol for wireless local area networks in which devices of the first class (legacy 802.11a) detect a primary BPSK during an initialization of a transmission burst. Devices of the second class also detect an additional (secondary) signal. From the secondary signal these devices learn that a transmission will be in a multiple input multiple output (mimo) mode that provides higher throughput and/or better reliability. For the mimo mode, the training sequence(s), protocol signaling(s) and/or the modulation method(s) differ from those in the legacy standard.

According to a first application, in a multi-device radio network, a central node (e.g. an access point, a residential gate way, a DVD+RW player etc.) sends messages to devices that adhere to a legacy standard as well as to devices that understand a new standard. For the legacy standard one might use 802.11a (further to be called 11a) as the reference here, and for the upcoming standard one might use 802.11n (further to be called 11n) as the example for the new standard. At the start of a transmission to new 11n devices, the central node needs to send control messages to all devices, including the 11a and the 11n types. Since the old devices need to understand that a transmission is started, the central node needs to transmit a signal in the form of a primary signal. Yet a new device must also understand that the transmission will be in a new format, this new device needs to receive a secondary signal that conveys this message. The secondary signal (message) is preferably embedded with the primary signal (message) where the primary signal causes the legacy devices to stay silent for a certain duration, as described in the primary signal. Such messages exist and are defined in the Media Access Control layer of the standard. In the example case 11a WiFi this message contains a bit rate, a coding and a number of bytes to be exchanged. Any receiver (legacy or new) can determine the duration of the transmission, as the length divided by the rate. To illustrate this all, in FIG. 5 a signal field in a 11a legacy transmission is shown (R=Rate, 4 bits, L=Length, 12 bits, and ST=SignalTail, 6 bits).

Upon a start of a transmission to a 11n device in a mimo mode, the transmitter picks an existing 11a mode, it selects certain bits R1-R4, and calculates how many bytes would need to be transmitted to create a virtual message of a length equal to that of the intended mimo transmission. The L(ength) field is set accordingly. Typically mimo signals are transmitted at a higher rate than 11a, thus the virtual message presumably has a larger value for its L(ength) than the real 11n message to for example have the same duration when for example expressed in seconds. The transmitter then seemingly starts a 11a transmission with a training sequence and a signal field message that contains the L(ength) parameter for such virtual message. However the transmitter also adds an embedded (secondary) message that informs mimo capable devices (11n devices) that in reality a mimo transmission will follow, which differs in at least one parameter from the parameters mentioned in the primary signal field message.

The secondary message then preferably carries already key parameters of the new transmission scheme. Examples of such parameters are a number of antennas in a mimo spatial multiplexing transmission, whether or not a space time block code or Alamouti scheme is applied, a bit rate, a coding rate, a choice of error correction code, a use of a channel bounding scheme with relative or absolute channel numbers, etc. As a consequence of receiving this primary and secondary message, legacy and new devices will understand that the channel will be busy, while the intended new device knows that it has to process the next stream in a new mimo mode.

According to second and further applications, the invention can also be applied in a non orthogonal frequency division multiplexing environment, such as for example a Bluetooth environment. Preferably a secondary direct-sequence spread spectrum signal is added to the primary Bluetooth signal, such that the chip rate of the secondary direct-sequence spread spectrum signal is equal to the symbol rate of the primary Bluetooth signal. The secondary direct-sequence spread spectrum signal can for instance carry parameters to control an Ultra Wide Band transmission.

In FIG. 6, an exemplary modulation is shown. The transmit signal is r(t)=r1(t)+r2(t) where r1(t) is the primary signal and r2(t) is the secondary signal. For example, r1(t)=+1 Volt or −1 Volt according to a primary message bit and r2(t)=+0.1 Volt or −0.1 Volt according to a secondary message bit. A receiver may preferably implement a slicer with at least three voltage levels: −1 Volt, 0 Volt and +1 Volt. A received signal s(t) would be decoded as follows:

| | | |
|---|---|---|
| s(t) < −1 Volt | primary message “0” | secondary signal “0” |
| −1 Volt < s(t) < 0 Volt | primary message “0” | secondary signal “1” |
| 0 Volt < s(t) < +1 Volt | primary message “1” | secondary signal “0” |
| s(t) > +1 Volt | primary message “1” | secondary signal “1” |

Evidently, if the channel contains noise, the bit error rate of the secondary signal will be substantially larger than the bit error rate of the primary signal. This effect can be compensated by a strong error correction code. In our example, a transmit sequence 10001 can be used to identify a logical “0” for the secondary signal and alternatively a transmit sequence 01110 can be used to identify a logical “1” for the secondary signal. In FIG. 6, the upper bits 11010 are primary signal bits and the lower bits 10001 are secondary signal bits.

An important set of applications might be where it is relevant to distinguish between a transmission with only a primary signal and a transmission with a primary and a secondary signal. In this embodiment, the receiver can for instance decide that the secondary signal was absent if the detected secondary signal sequence does neither closely match 10001 nor 01110. Here, a close match may be defined as a Hamming distance of one symbol or less. A sequence 10000 would be accepted as a secondary message “0”, but a secondary signal 01001 would be interpreted as secondary message being absent.

In FIG. 7, an exemplary modulation constellation is shown (a signal constellation for a hierarchical modulation). This is a more sophisticated embodiment. Of an orthogonal frequency division multiplexing signal with 64 sub-carriers, each sub carrier contains a quadrature amplitude modulation symbol. A subset of points in a 16, 64, or 256 quadrature amplitude modulation signal is used. The horizontal axis defines a quadrature component, the vertical axis defines an inphase component. A 64 quadrature amplitude modulation signal constellation is used as reference grid. A primary message “0” or “1” is transmitted by either selecting a point in the upper or in the lower area. A secondary message is embedded by selecting one out of the four points within the chosen area. The reliability of the secondary message is enhanced by combing energy in multiple sub carriers, e.g. by using Multi-Carrier-CDMA (MC-CDMA) or Coded-OFDM.

It should be noted that in prior art analog military speech communication systems, there has been a need for a strong digital authentication of the transmitter and that it has been suggested to add a direct sequence spread-spectrum digital signal with a low bit rate to a FM-modulated analog speech signal. The spread spectrum signal contains a digital signature of the transmitter or of the user that operates the transmitter. In Radio Data Systems (RDS) it has been proposed to add a digital signal to a FM radio broadcast signal. Here a slow digital signal of a few tens of kbit/s is located outside the analog multiplex of the mono and stereo audio signals. These signals are jointly FM modulated. In contrast to this, the invention predominantly applies to a primary and secondary signal that both are digital.

Watermarking (I. J. Cox, M. Miller, J. P. M. G. Linnartz and A. C. C. Kalker, “A review of watermarking principles and practices”, Chapter 17 of “Digital Signal Processing for Multimedia Systems”, K. K. Parhi and T. Nishitani (eds.), Marcel Dekker, Inc., New York, March 1999) is a known method for “embedding” additional data (e.g. copy right information) into an audio or a video content. Here the content acts as the primary signal and the watermark payload acts as the secondary signal. According to the invention, watermarking techniques are applied such that the secondary signal comprises one or more signaling messages in one or more communication protocols, and/or watermarking techniques are applied such that the primary signal comprises one or more signaling messages in one or more communication protocols. Watermarking techniques can also be applied such that the primary signal comprises one or more signaling messages in one or more legacy communication protocols (e.g. Wifi IEEE 802.11a, Bluetooth) and at the same time the secondary signal comprises one or more signaling messages relevant to newer generations of devices (e.g. 802.11n, new generation LAN or PAN standards).

Hierarchical modulation is a known concept to broadcast information to a set of receivers each having its own link quality. The modulation is chosen such that receivers with a good channel can extract all (primary and secondary) information, whereas receivers with a poor channel can still recover at least a part of the (primary) information. This part is chosen such that it forms a consistent information content. It has been proposed in the past for digital television broadcast. Typically this primary information is a video stream in a lower resolution. With the secondary information, a higher resolution video can be achieved. According to the invention, hierarchical modulation is applied such that the secondary signal comprises one or more signaling messages in one or more communication protocols. The idea can be applied to a variety of primary messages including training sequences, protocol control messages and/or user data payload. Hierarchical modulation can also be applied such that the primary signal comprises one or more signaling messages in one or more communication protocols. Hierarchical modulation can also be applied such that the primary signal comprises one or more signaling messages in one or more legacy communication protocols (e.g. Wifi IEEE 802.11a, Bluetooth) and at the same time the secondary signal comprises one or more signaling messages relevant to newer generations of devices (e.g. 802.11n, new generation LAN or PAN standards). Similarly, the secondary signal may comprise one or more signaling messages relevant to more powerful devices, whereas the primary message is only detected by low power devices.

Hierarchical coding can be employed in a setting where receivers from different classes (e.g. legacy and new ones) all need to operate reliably. The primary message shall be decoded reliably by all receivers, while the weaker secondary message shall be equivalently reliable. This can be achieved by including a strong coding gain or a spreading gain into the secondary signal that compensates for the weaker signal power in the secondary signal. This is in contrast to conventional operation modes of hierarchical coding, where a secondary signal often has a larger rate than the primary one, but where the secondary signal can only be recovered under good channel conditions.

Multi-Carrier CDMA is a form of a spread spectrum which combines direct sequence CDMA with OFDM transmission. MC-CDMA has been disclosed in public literature in 1993 (N. Yee, J. P. M. G. Linnartz and G. Fettweis, “Multi-Carrier CDMA in indoor wireless Radio Networks”, IEEE Personal Indoor and Mobile Radio Communications (PIMRC) Int. Conference, September 1993, Yokohama, Japan, pp. 109-113.). MC-CDMA has been proposed for transmitting information such as a video stream and is seen as an alternative for Coded OFDM. According to the invention, MC-CDMA can be overlaid as a secondary signal on top of a primary OFDM signal.

The invention can be applied in receivers and transmitters for wireless communication. Hence it improves the operation of devices that rely on wireless links. The invention can be used in consumer electronics devices (television, wireless router, hub, wireless video streamers, clients for wireless video distribution, video, music and image storage devices) that have digital wireless links, but also in professional, corporate, military devices that control or transmit via digital wireless links. It can be used to apply specific extensions for a hospital network or devices that are based on public wireless LAN standards. The solution can be applied in vehicular communication, e.g., between cars, or between a car and a roadside communication post.

The solution can be used by a system of a secondary standard, which wants to ensure that devices that understand a primary standard remain silent during a certain period. Often, it is defined in the PHY or MAC layer of a standard that devices should listen to a channel for an ongoing transmission. Particularly if a message is intercepted which indicates that the channel will be busy for a certain period of time, other devices will remain silent during that period. According to the invention, the primary message is chosen accordance with the primary standard, and the secondary message is chosen in to be understood by devices that are conform to the secondary standard. The secondary standard might be 802.11n, and the primary standard might be 802.11a or 802.11g. The secondary standard might be WLAN with a throughput above 1 Gbit/s, and the primary standard might be 802.11n. The secondary standard might be a hospital network, and the primary standard might be 802.11a or 802.11g. This without excluding further examples.

It should further be noted that, for a compliance of legacy devices, 11n transmissions may start with a 11a preamble, to signal a busy channel to the 11a devices. After this preamble, any 11a device must understand for what duration the channel is busy, the targeted 11n device must understand that a mimo transmission will follow, and the targeted 11n device must know the bit rate and coding scheme to be used. The setting of the embedding may be such that a 11a training sequence is followed by a 11a signal field, which 11a signal field further comprises an embedded signal. This embedded signal may comprise a 11n training sequence followed by a 11n signal field followed by a 11n payload, or a 11n signal field followed by a 11n training sequence followed by a 11n payload, or a 11n training sequence followed by a 11n payload, without excluding further options.

About FIG. 7, the principle of the embedding is as follows. A BPSK signal forms a subset of a QAM signal. The 11a device does not distinguish the fine QAM signal, but only sees the BPSK signal, and the 11n device combines the signals from the multiple sub carriers to compensate for the weaker amplitude. The 11n signaling is for example seven times smaller, but consists of an addition of components from 48 sub carriers (and multiple antennas). The format of the embedding may be as follows. A 4-bit rate signaling field in the 11a signal determines a duration of a busy period for 11a and determines a set of choices for 11n. Of a 4-bit embedded mimo signaling field, two bits define the number of parallel streams (00: 2 stream STBC Alamouti (optional), 01: 2 streams, 10: 3 streams (optional), 11: 4 streams (optional)), and two bits define the code rate (00 as in a 11a field, 01 is an alternative rate, 11 for future upgrades (ignore payload, consider channel as busy), 10 to activate a mimo repeater).

The 11a standard defines a preamble to be followed by a signal field to be followed by a MAC header and data. A TGnSync draft proposes a preamble to be followed by a spoofed signal to be followed by a HT signal to be followed by a mimo training to be followed by a MAC header and data. According to the invention, for example a preamble is followed by a spoofed signal comprising an embedded signal and to be followed by a mimo training to be followed by a HT signal to be followed by a MAC header and data. The embedded signaling informs the 11n receiver about the kind of mimo training sequence that follows it and should not disturb the decoding of the signal field by a 11a device. The pros compared to the current TGnSync are no need for a 90° rotated BPSK mode for the HT-signal field, the 11n device does not need to do simultaneous processing of the HT-signal field in two modes, right after the spoofed signal field a 11n receiver knows what to do, additional training sequences can come before the HT-signal field, so the HT-signal field may be sent in a multiple-antenna mode, and the 11n receiver can detect the embedding at not too low SNR. The cons compared to the current TGnSync is a 0.46 dB loss compared to a pure BPSK SIGNAL field, but this will only affect signaling to legacy 11a devices that have a very bad channel.

The embedding may use some of the 16-QAM constellation points. On the 48 data-carrying sub carriers in the signal field of a 11n frame, the BPSK symbols ±1 are not sent, but one of the neighbors±(3±i)/(10)^{1/2} from the 16-QAM constellation, these already have the right energy (no rescaling needed). About a detection by a 11a device, if one of the constellation points (3±i)/(10)^{1/2} is used instead of 1 (and similarly for the other points), the probability of a single bit error in sub carrier n is ½ erfc {3/(10)^{1/2}(γₙ)^{1/2}} instead of ½ (γₙ)^{1/2} where γₙ is the SNR in the nth sub carrier. To get the same error probability as for a pure 11a signal field, γₐᵥ must be 10/9 times as large. This corresponds with 0.46 dB loss.

For a low rate 16-QAM code, the embedded signal in sub carrier n can be defined as

bₙ=0 if ±1 is sent, bₙ=±1 if ±(3+i)/(10)^{1/2} is sent, and bₙ=±(3−i)/(10)^{1/2} is sent. Thereby, K+1 code words B=(b₁, . . . , b₄₈) are defined, whereby B₀=(0, 0, . . . , 0) forms a 11a frame and Bᵢ={±1}⁴⁸ for i=1, . . . K, forms a 11n frame in some mode, indicated by i.

The transmitter sends the 11a signal field X=(x₁, . . . , x₄₈) and the embedded codeword B: sₙ=xₙ exp(iθbₙ) with θ=arctan(1/3).

About a detection of an embedded signal, a received signal rₙ=Hₙsₙ+Nₙ. For a detection by a 11n device, according to a first step, the 11a signal field X is detected, just like a 11a device would do. If this went right, then, according to a second step, a MMSE detection of the embedded signal is performed:

B′=argmin for B={B₀,B₁, . . . , B_{K}} of a SUM from n=1 to 48 of |rₙxₙ−Hₙ exp(iθbₙ)², see also FIGS. 2 and 3 and their description. In particular, the watermark detector 27 performs this B′ operation, and the mapper 16 produces the sₙ=xₙ exp(iθbₙ) operation.

The IEEE 802.11n (11n, for short) standard is to be the successor to the IEEE 802.11a (11a, for short) standard. Both standards operate in the same frequency bands, but 11n will have ‘high throughout’ modes that a 11a device cannot decode. Legacy 11a devices and new 11n devices will likely coexist for some time, and they must be able to operate in the same frequency band simultaneously (20 MHz band). Easy “solutions”, in which 11n frames need not be ‘compatible’ to. 11a frames, but 11n STAs have a 11a mode, are for example:

all 11n devices fall back to 11a mode if a 11a STA is present;

11n AP does not let 11a devices associate;

if a 11a STA is present, 11n devices always use 11a RTS/CTS frames prior to 11n frame transmission; the 11a devices update their NAV and ignore the 11n frame;

CTS-to-self has less overhead, but is not as clean, since the intended receiver is not known.

The first solution is what is currently being used in a mixed 11b/g network. People who have bought 11g hardware and who still use their old 11b devices see no performance increase. The second solution (no compromises to legacy devices) may be technically the best solution, but it's not compatible. However, it makes sense to have a mode in which 11a devices cannot associate to a 11n access point.

It is an object to realize a mode in which 11n and 11a are as compatible as possible without giving up the fast modes between 11n devices. A 11n frame is signaled as follows. If every 11n frame starts with a 11a preamble and a 11a signal field (just like a 11a frame) in such a way that 11a STAs can deduce the duration of the frame (they won't be able to decode it, so it would be better if that could be signaled as well) and that 11n STAs can deduce the duration of the frame and detect that it is not a 11a frame, but a 11n frame, so that they can interpret it properly. Then reception of 11n frames by 11n STAs is possible, while 11a STAs know at least how long the 11n transmission takes, so that they won't consider the 11n frame as complete gibberish and (depending on the CCA mechanism they use) send their own messages anyway, or disassociate from the network. This can be arranged by the following steps:

Step 1: For a mimo transmitter with N antennas, let the 11n preamble consist of N 11a preambles, the jth of which is formed by letting antenna i transmit Qij×11a preamble signal. If Q has rank N (e.g., if it is orthogonal), the full channel matrix can be estimated.

Step 2: Send out the first phase of the preamble (with a first column of Q) followed by the signal field (also with the first column of Q); the rate and the length fields should be set so that a 11a STA can calculate the duration of the entire frame.

Step 3: Whether N>1 is to be signaled and, if so, the value of N.

Step 4: Send the remaining N−1 phases of the preamble (with columns 2, . . . , N) followed by a new 11n signal field informing the receiver about the number of bytes, modulation and coding used in the rest of the frame.

In the 11a signal field there is one bit that is ‘reserved for future use’, but it is not required to be 0 for 11a. So that signaling must be done in another way. A possible solution might be an embedding in the preamble via a power modulation. In a long preamble all 52 sub carriers are used, with amplitudes Li=±1. If these amplitudes are modified somewhat:

Lᵢ=(1+αwᵢ)^{1/2}Lᵢ, where 0<α<1 and wᵢ={−1, +1} with a SUM from i=1 to 52 of wᵢ is equal to zero, the total transmitted energy remains the same. In the following signal field the same multiplications are used. A 11a STA receiving this preamble will conclude that the channel is wild, but it can still decode the signal field. It cannot decode the rest of the packet, as it is sent in 11n mode. A 11n STA must conclude from the presence of a modulation with pattern wᵢ that the frame is a 11n frame, estimate the channel, correct for the known αwᵢ, and switch to the 11n mode.

About watermark detection, the 11n receiver measures the received power Pᵢ in each sub carrier and calculates S=SUM from i=1 to 52 of Pᵢ and T=SUM from i=1 to 52 of Pᵢwᵢ. The idea is that T is substantially equal to αS. This works perfectly if the channel is flat fading (i.e. equal in all sub carriers, Pᵢ=(1+αwᵢ)P for all i). Variable decision ρ:=T/S. The threshold is θ, if ρ>θ the watermark is assumed to be present, if ρ<θ it is assumed to be absent. The threshold θ should be in (0, α).

It should be yet further noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually dependent claims does not indicate that a combination of these measures cannot be used to advantage.

1. A transmitter (1) for transmitting information to a receiver (2), which information comprises a primary message and a secondary message combined in a same transmission, which primary and secondary messages comprise communication protocol signaling messages.

2. The transmitter (1) as defined in claim 1, the primary communication protocol message being in accordance with a first standard and the secondary communication protocol message being in accordance with a second standard, the receiver (2) being able to detect the primary communication protocol message in case of the receiver (2) being in accordance with the first standard and the receiver (2) being able to detect the secondary communication protocol message in case of the receiver (2) being in accordance with the second standard.

3. The transmitter (1) as defined in claim 2, the first standard being 802.11a and the second standard being a later standard.

4. The transmitter (1) as defined in claim 1, the primary and secondary messages being digital messages.

5. The transmitter (1) as defined in claim 1, the secondary message being embedded in the primary message via a modulation of at least a part of the primary message and/or via a selection of a subset of a set of a modulation constellation, the set of the modulation constellation being used as a reference grid.

6. The transmitter (1) as defined in claim 1, the secondary message defining a type of frame used in the information and/or a number of antennas used by the transmitter (1) and/or a scheme and/or a rate and/or a code.

7. A receiver (2) for receiving information from a transmitter (1), which information comprises a primary message and a secondary message combined in a same transmission, which primary and secondary messages comprise communication protocol signaling messages.

8. The receiver (2) as defined in claim 7, the primary communication protocol message being in accordance with a first standard and the secondary communication protocol message being in accordance with a second standard, the receiver (2) being able to detect the primary communication protocol message in case of the receiver (2) being in accordance with the first standard and the receiver (2) being able to detect the secondary communication protocol message in case of the receiver (2) being in accordance with the second standard.

9. The receiver (2) as defined in claim 8, the first standard being 802.11a and the second standard being a later standard.

10. The receiver (2) as defined in claim 7, the primary and secondary messages being digital messages.

11. The receiver (2) as defined in claim 7, the secondary message being embedded in the primary message via a modulation of at least a part of the primary message and/or via a selection of a subset of a set of a modulation constellation, the set of the modulation constellation being used as a reference grid.

12. The receiver (2) as defined in claim 7, the secondary message defining a type of frame used in the information and/or a number of antennas used by the transmitter (1) and/or a scheme and/or a rate and/or a code.

13. A device (100) comprising the transmitter (1) as defined in claim 1.

14. A method for exchanging information between a transmitter (1) and a receiver (2), which information comprises a primary message and a secondary message combined in a same transmission, which primary and secondary messages comprise communication protocol signaling messages.

15. The method as defined in claim 14, the primary communication protocol message being in accordance with a first standard and the secondary communication protocol message being in accordance with a second standard, the receiver (2) being able to detect the primary communication protocol message in case of the receiver (2) being in accordance with the first standard and the receiver (2) being able to detect the secondary communication protocol message in case of the receiver (2) being in accordance with the second standard.

16. The method as defined in claim 15, the first standard being 802.11a and the second standard being a later standard.

17. The method as defined in claim 14, the primary and secondary messages being digital messages.

18. The method as defined in claim 14, the secondary message being embedded in the primary message via a modulation of at least a part of the primary message and/or via a selection of a subset of a set of a modulation constellation, the set of the modulation constellation being used as a reference grid.

19. The method as defined in claim 14, the secondary message defining a type of frame used in the information and/or a number of antennas used by the transmitter (1) and/or a scheme and/or a rate and/or a code.

20. A signal to be exchanged between a transmitter (1) and a receiver (2), which signal comprises a primary message and a secondary message combined in a same transmission, which primary and secondary messages comprise communication protocol signaling messages.
